(19) United States
(12) Patent Application Publication
(10) Pub. No.: US 2025/0215850 A1
(43) Pub. Date: Jul. 3, 2025

(54) PRESSURE MEDIUM POWERED DEVICE GENERATING RECIPROCATING MOTION

(71) Applicant: DYNASET OY, Ylöjärvi (FI)

(72) Inventor: Pasi YLI-KÄTKÄ, Ylöjärvi (FI)

(21) Appl. No.: 18/848,221

(22) PCT Filed: Mar. 15, 2023
(86) PCT No.: PCT/FI2023/050145

§ 371 Date: Sep. 18, 2024

(30) Foreign Application Priority Data
Mar. 18, 2022 (FI) 20225243

(51) Int. Cl. F03C 1/28; F03C 1/06

(52) U.S. Cl. CPC F03C 1/0605; F03C 1/0607

(57) ABSTRACT

A pressure medium powered device generating a reciprocating motion, which includes a body (5), a primary piston (2), a control valve assembly, and at least one secondary piston (3, 4). The primary piston (2) is fitted inside the body (5). The control valve assembly is configured to move the primary piston (2) back and forth. The secondary piston (3, 4) is attached to the primary piston (2). The primary piston (2) includes a first conical surface (20) and the secondary piston (3, 4) includes a corresponding second conical surface (21), whereby the primary piston (2) and the secondary piston (3, 4) are aligned to each other by means of the first conical surface (20) and the second conical surface (21).

### BACKGROUND OF THE INVENTION

The invention relates to a pressure medium powered device generating a reciprocating motion.

For such a device, it is important that it is reliable, durable and accurate. Therefore, special knowhow, accuracy and meticulousness are required in the manufacture of the device.

### BRIEF DESCRIPTION OF THE INVENTION

The object of the invention is thus to develop of novel kind of a pressure medium powered device generating a reciprocating motion. The arrangement according to the invention is characterised by what is disclosed in the independent claims. Some embodiments of the invention are disclosed in the dependent claims.

Here, a pressure medium powered device generating a reciprocating motion is presented. The device includes a body, a primary piston which is fitted inside the body, a control valve assembly which is configured to move the primary piston back and forth, and at least one secondary piston which is attached to the primary piston. The primary piston includes a first conical surface and the secondary piston includes a corresponding second conical surface, whereby the primary piston and the secondary piston are aligned to each other by means of the first and the second conical surface. By such an arrangement, the device can be formed in a simple and reliable way such that the connected parts are extremely well straight in relation to each other.

According to an embodiment, the central axis of the primary piston and the central axis of the secondary piston are on the same axis line. Hence, the device is symmetrical and balanced.

According to an embodiment, the end of the secondary piston is fitted inside the primary piston, whereby the conical surface of the primary piston is the inner surface of the cone and the conical surface of the secondary piston is the outer surface of the cone. Such an arrangement provides extremely reliably aligned parts.

According to an embodiment, the front surface of the primary surface facing the secondary piston does not touch the secondary piston. Then, the conical surface aligns the primary piston and the secondary piston very accurately in relation to each other.

According to an embodiment, the primary piston and the secondary piston are attached to each other by a thread connection. This type of a connection is simple, reliable and dependable.

According to an embodiment, the conical ratio of the conical surfaces is 1:20 or larger and, according to a further embodiment, the conical ratio of the conical surfaces is 1:1 or smaller. Such conical ratios provide a reliable and accurate alignment.

According to an embodiment, the device is a booster pump. In connection with the booster pump, it is especially important that the primary piston and the secondary piston can be accurately arranged straight in relation to each other.

### BRIEF DESCRIPTION OF THE DRAWINGS

The invention will now described in closer detail in connection with some embodiments and with reference to the accompanying drawings, in which:

FIG. 1 is a schematic cross-sectional side view of a booster pump;

FIG. 2 is a schematic side view of a primary piston, to which, two secondary pistons are attached;

FIG. 3 is a schematic cross-sectional side view of an attachment point of the primary piston and the secondary piston; and

FIG. 4 is a schematic cross-sectional side view of an attachment point of a primary piston and a secondary piston according to another embodiment.

### DETAILED DESCRIPTION OF THE INVENTION

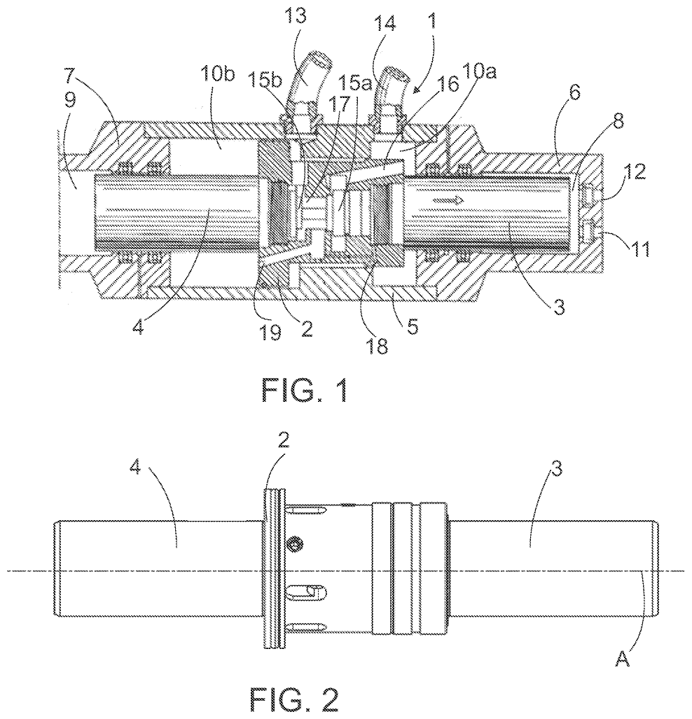

FIG. 1 shows a booster pump 1. The booster pump 1 shown in FIG. 1 is a hydraulically driven pump of a pressure washer.

The booster pump 1 includes a primary piston 2. To the primary piston 2 are attached a first secondary piston 3 and a second secondary piston 4. The secondary piston 2 is fitted inside a body 5. The first secondary piston 3 extends inside a first cylinder 6. Correspondingly, the second secondary piston 4 extends inside a second cylinder 7. The cylinders 6 and 7 and the body 5 are simple cylindrical pieces.

Inside the first cylinder 6, there is a first cylinder space 8 and, inside the second cylinder 7, there is a second cylinder space 9. Inside the body 5, there are drive fluid spaces 10a and 10b. The cylinder spaces 8 and 9 are separated from the drive fluid spaces 10a and 10b by sealings. The sealings can be a pair of seals. Between the pair of seals, there can be a seepage flow channel.

The primary piston 2 moves back and forth inside the body 5, and the secondary pistons 3 and 4 attached to the primary piston 2 perform the pumping. Reference number 11 shows a water inlet pipe, and reference number 12 shows a water pressure pipe. An inlet pipe of pressure fluid is shown by reference number 13. A return pipe of pressure fluid is shown by reference number 14.

The control valve assembly moving the primary piston 2 back and forth is fitted inside the primary piston 2 in the embodiment of FIG. 1. The control valve assembly comprises a control valve which includes a valve bucket 15a and a valve stem 15b.

In the situation of FIG. 1, the primary piston 2 and the secondary pistons 3 and 4 being attached to it have moved in the direction shown by the arrow, that is, to the right as seen in FIG. 1. FIG. 1 illustrates a situation where the motion of the pistons is at the right extreme end. However, the valve bucket 15a and the valve stem 15b are still in the position that equally the same pressure affect on different sides A and B of the primary piston 2 and, due to the larger area of the side B, the pressurised fluid pushes the pistons further to the right. The valve stem 15a closes a channel 16 and, correspondingly, the valve stem 15b is in a position where an opening 17 is open.

In the situation of FIG. 1, a seepage flow channel 18 has just reached the drive fluid space 10a. Due to this, the pressure on the right hand side of the valve bucket 15a as seen in FIG. 1 is decreasing. The pressure through the opening 17 to the valve bucket 15a transfers the valve bucket 15a and the valve stem 15b to the right. Then, the valve bucket 15a lets the channel 16 to open and the valve stem 15b closes the opening 17. Pressurised fluid in the drive fluid space 10b exits along channels 19 and 16 to the return pipe 14. Pressurised fluid entering from the inlet pipe 13 affects the ring surface A of the primary piston 2 and pushes the primary piston 2 to the left as seen in FIG. 1.

The valve bucket 15a and the valve stem 15b remain in the right-hand position as the primary piston 2 moves to the left. When the primary piston 2 reaches its left-hand-side extreme position, the seepage fluid channel 18 reaches the drive fluid space 10b. Then, the pressure on the right-hand side of the valve bucket 15a increases, which makes the valve bucket 15a and the valve stem 15b to transfer to the left again. The channel 16 is then again closed and the opening 17 opened and the primary piston starts to move to the right.

In the embodiment of FIG. 1, the control valve assembly is thus configured such that the control valve and control channels are fitted inside the control piston 2. It is obvious to those skilled in the art that the control valve assembly can also be implemented in some other way.

FIG. 2 shows the primary piston 2 and the first secondary piston 3 and the second secondary piston 4 attached to it. The central axis of the primary piston 2 and the central axes of the secondary pistons 3 and 4 are on the same axis line A.

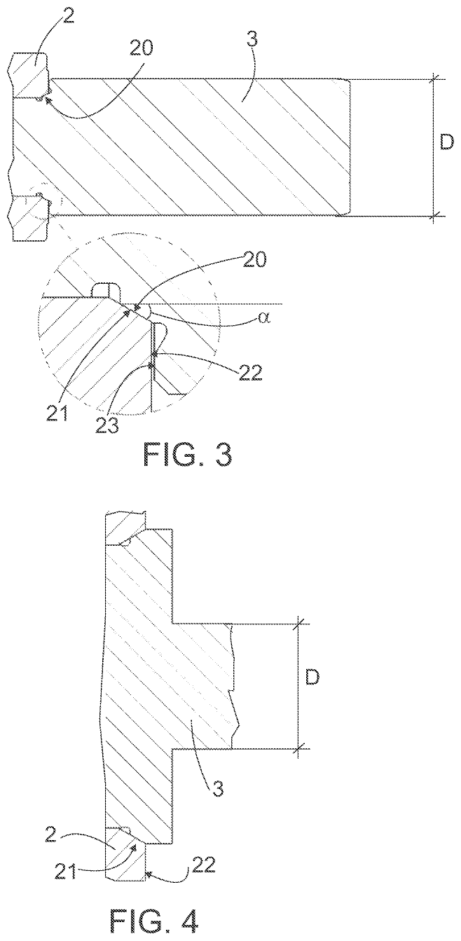

FIG. 3 shows a detail on the attachment of the primary piston 2 and the secondary piston 3 to each other. The primary piston 2 and the secondary piston 3 can be attached to each other, for example, by a thread connection. It is also possible to attach the primary piston 2 and the secondary piston 3 to each other in some other way, such as by a cotter, a wedge, a spring, or a crimp connection.

The primary piston 2 includes a first conical surface 20. The secondary piston 3 includes a corresponding second conical surface 21. The primary piston 2 and the secondary piston 3 are aligned to each other by arranging the first conical surface 20 and the second conical surface 21 to face and touch each other. The end of the secondary piston 3 is fitted inside the primary piston 2. Then, the conical surface 20 of the primary piston 2 is the inner surface of the cone and the conical surface 21 of the secondary piston 3 is the outer surface of the cone.

The conical ratio of the conical surfaces can be e.g. 1:20 or larger. Then, the conical angle α is about 3° or larger. Furthermore, the conical ratio of the conical surfaces can be e.g. 1:1 or smaller. Then, the conical angle α is about 45° or smaller.

In the embodiment of FIG. 3, a piston diameter D of the secondary piston 3 is larger than the perimeter diameter i.e. largest diameter of the control cone forming its conical surface 21. Furthermore, the secondary piston 3 and the primary piston 2 are attached to each other such that a front surface 22 of the primary piston 2 facing the secondary piston 3 is arranged at a distance from a surface 23 of the secondary piston 3 facing the primary piston 2. Then, the front surface 22 of the primary surface 2 facing the secondary piston 3 does not touch the secondary piston 3.

In the embodiment of FIG. 4, the piston diameter D of the secondary piston 3 is smaller than the perimeter diameter i.e. largest diameter of the control cone forming its conical surface 21. Then, no part of the secondary piston 3 faces the front surface 22 of the primary piston 2. Even then, the front surface 22 of the primary surface 2 facing the secondary piston 3 does not touch the secondary piston 3.

The pressure medium powered device generating a reciprocating motion shown in FIG. 1 is a booster pump 1. The presented arrangement for aligning the primary piston 2 and the secondary piston 3, 4 to each other can also be applied in connection with primary and secondary pistons of some other pressure medium powered device generating a reciprocating motion. Such a device can be e.g. a stem of a hydraulic valve. The stem can consist of two parts, in the connection of which, the above presented arrangement is applied.

Those skilled in the art will find it obvious that, as technology advances, the basic idea of the invention can be implemented in many different ways. The invention and its embodiments are thus not restricted to the examples described above but may vary within the scope of the claims.

1. A pressure medium powered device generating a reciprocating motion, which includes a body, a primary piston which is fitted inside the body, a control valve assembly which is configured to move the primary piston back and forth, and at least one secondary piston which is attached to the primary piston, wherein the primary piston includes a first conical surface and the secondary piston includes a corresponding second conical surface, whereby the primary piston and the secondary piston are aligned to each other by means of the first conical surface and the second conical surface.

2. A device according to claim 1, wherein a central axis of the primary piston and a central axis of the secondary piston are on the same axis line.

3. A device according to claim 1, wherein the end of the secondary piston is fitted inside the primary piston, whereby the conical surface of the primary piston is the inner surface of the cone and the conical surface of the secondary piston is the outer surface of the cone.

4. A device according to claim 1, wherein the front surface of the primary surface facing the secondary piston does not touch the secondary piston.

5. A device according to claim 1, wherein the primary piston and the secondary piston are attached to each other by a thread connection.

6. A device according to claim 1, wherein the conical ratio of the conical surfaces is 1:20 or larger.

7. A device according to claim 1, wherein the conical ratio of the conical surfaces is 1:1 or smaller.

8. A device according to claim 1, wherein the device is a booster pump.
